(19) United States
(12) Patent Application Publication
(10) Pub. No.: US 2009/0129559 A1
(43) Pub. Date: May 21, 2009

(54) COMMUNICATION APPARATUS, COMMUNICATION METHOD AND COMPUTER READABLE MEDIUM

(75) Inventors: Kentaro FUKAMI, Saitama-shi (JP); Naoki Sutoh, Saitama-shi (JP); Hideo Ishizu, Saitama-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX., CO., LTD., Tokyo (JP)

(21) Appl. No.: 12/124,852

(22) Filed: May 21, 2008

(30) Foreign Application Priority Data
Nov. 20, 2007 (JP) 2007-301026

(51) Int. Cl. H04M 1/24

(52) U.S. Cl. 379/24

(57) ABSTRACT

A communication apparatus is provided with: plural transmission units that respectively transmit communication signals through a telephone line; a detection unit that detects a value of a line voltage supplied from the telephone line to each of the plural transmission units; and a controller that controls transmission from each of the plural transmission units, according to a relation between a predetermined reference voltage value and the value of the line voltage of each of the plural transmission units detected by the detection unit.

### CROSS REFERENCE TO RELATED APPLICATIONS

This application is based on and claims priority under 35 USC §119 from Japanese Patent Application No. 2007-301026 filed Nov. 20, 2007.

### BACKGROUND

1. Technical Field

The present invention relates to a communication apparatus, a communication method and a computer readable medium storing a program.

2. Related Art

In a general communication apparatus such as a facsimile and a telephone, a single transmission and reception apparatus is connected to a single telephone line for transmitting and receiving data such as image information and audio information. Meanwhile, in recent years, a communication apparatus that is equipped with plural transmission and reception apparatuses which are respectively connected to a different telephone lines and in which data such as image information and audio information are transmitted and received is used.

### SUMMARY

According to an aspect of the present invention, there is provided a communication apparatus including: plural transmission units that respectively transmit communication signals through a telephone line; a detection unit that detects a value of a line voltage supplied from the telephone line to each of the plural transmission units; and a controller that controls transmission from each of the plural transmission units, according to a relation between a predetermined reference voltage value and the value of the line voltage of each of the plural transmission units detected by the detection unit.

### BRIEF DESCRIPTION OF THE DRAWINGS

Exemplary embodiment(s) of the present invention will be described in detail based on the following figures, wherein:

FIG. 1 is a functional block diagram illustrating a configuration of an image forming apparatus to which the exemplary embodiment is applied;

FIG. 2 is a block diagram for explaining a detailed configuration of the first communication part included in the above-mentioned FAX communication unit;

FIG. 3 is a flowchart illustrating a procedure of the various kinds of processing that is performed for the FAX communication unit of the image forming apparatus;

FIG. 4 is a flowchart illustrating the detailed processing procedure of the connection line checking operation mentioned above; and

FIG. 5 is a flowchart illustrating the detailed processing procedure of the FAX transmission operation as mentioned above.

### DETAILED DESCRIPTION

Hereinafter, a detail description will be given for a case where the present invention is applied to a facsimile as an exemplary embodiment of the present invention with reference to the attached drawings.

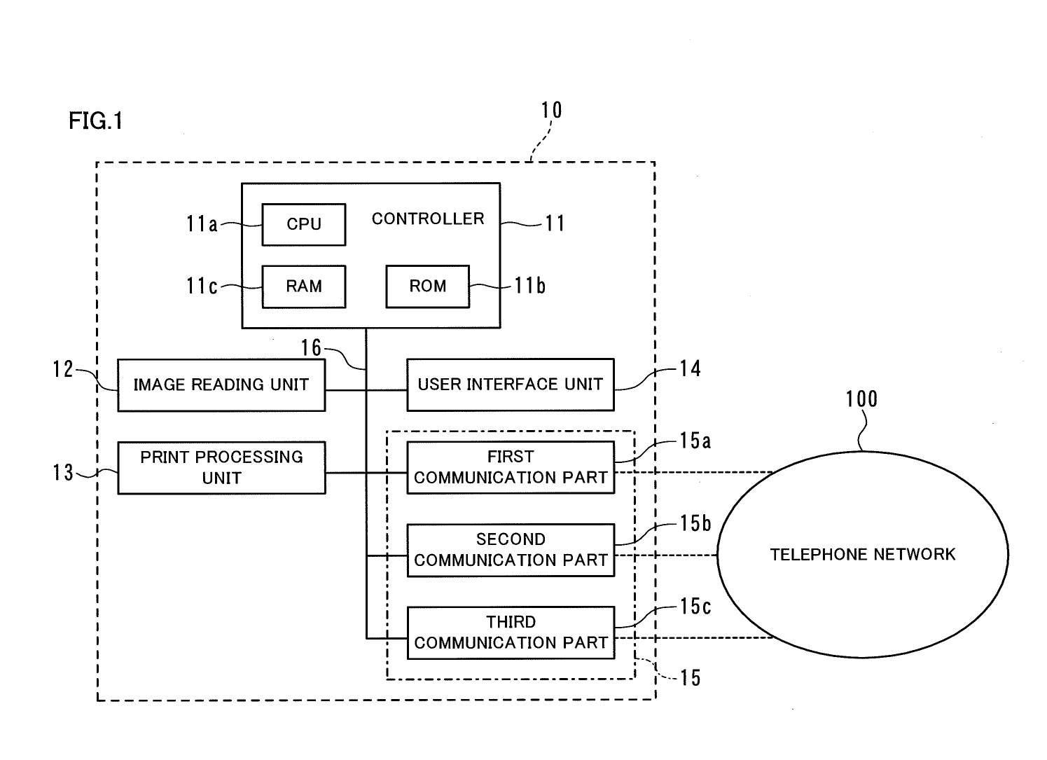

FIG. 1 is a functional block diagram illustrating a configuration of an image forming apparatus 10 to which the exemplary embodiment is applied. The image forming apparatus 10 has a scanner function, print function, facsimile function and the like, in addition to a so-called copy function.

The image forming apparatus 10 is provided with a controller 11, an image reading unit 12, a print processing unit 13, a user interface unit 14 and a FAX communication unit 15. They are connected to each other through a bus line 16. Here, the FAX communication unit 15 is provided with a first communication part 15a, a second communication part 15b and a third communication part 15c. They are individually connected to the bus line 16. To the image forming apparatus 10, a telephone network 100 is connected through the first to third communication parts 15a to 15c that are included in the FAX communication unit 15. Here, different telephone numbers are assigned to the first to third communication parts 15a to 15c. As the telephone network 100, a public line network, an internal line network or the like is exemplified.

In the image forming apparatus 10, the controller 11 is provided with a CPU (Central Processing Unit) 11a, a ROM (Read Only Memory) 11b and a RAM (Random Access Memory) 11c. The CPU 11a that functions as a controller and an instruction unit reads a program stored in the ROM 11b, executes the read program while transmitting and receiving data to and from the RAM 11c appropriately, and controls entire operation of the image forming apparatus 10 including the image reading unit 12, the print processing unit 13, the user interface unit 14 and the FAX communication unit 15.

The image reading unit 12 reads an image formed on a manuscript (not illustrated in the figure), and outputs the acquired image signal through the bus line 16.

The print processing unit 13 receives, through the bus line 16, the image signal that has been acquired by reading the manuscript by the image reading unit 12 and an image signal that has been received from the external through the FAX communication unit 15, and forms an image on a paper sheet based on the received image signals.

The user interface unit 14 that functions as a reception unit receives user's request of, for example, a destination of a facsimile, and displays a message or the like for the user.

The first to third communication parts 15a to 15c as plural transmission units that are included in the FAX communication unit 15 functioning as a communication apparatus have a function of generating a transmission signal based on, for example, the image signal acquired by reading a manuscript by the image reading unit 12, and outputting the transmission signal to the external telephone network 100, respectively. Alternatively, a transmission signal may be generated based on the image signal acquired through a network (not illustrated in the figure), and may be outputted to the external telephone network 100. Further, the first to third communication parts 15a to 15c that are included in the FAX communication unit 15 have a function of generating an image signal based on the transmission signal received from the external through the telephone network 100, and outputting the image signals that have been generated through the bus line 16, respectively. The first to third communication parts 15a to 15c independently work. Therefore, for example, all of the first to third communication parts 15a to 15c may be used to perform transmission or reception at the same time. Alternatively, for example, while the first communication part 15a performs transmission, the second and third communication parts 15b and 15c may perform reception.

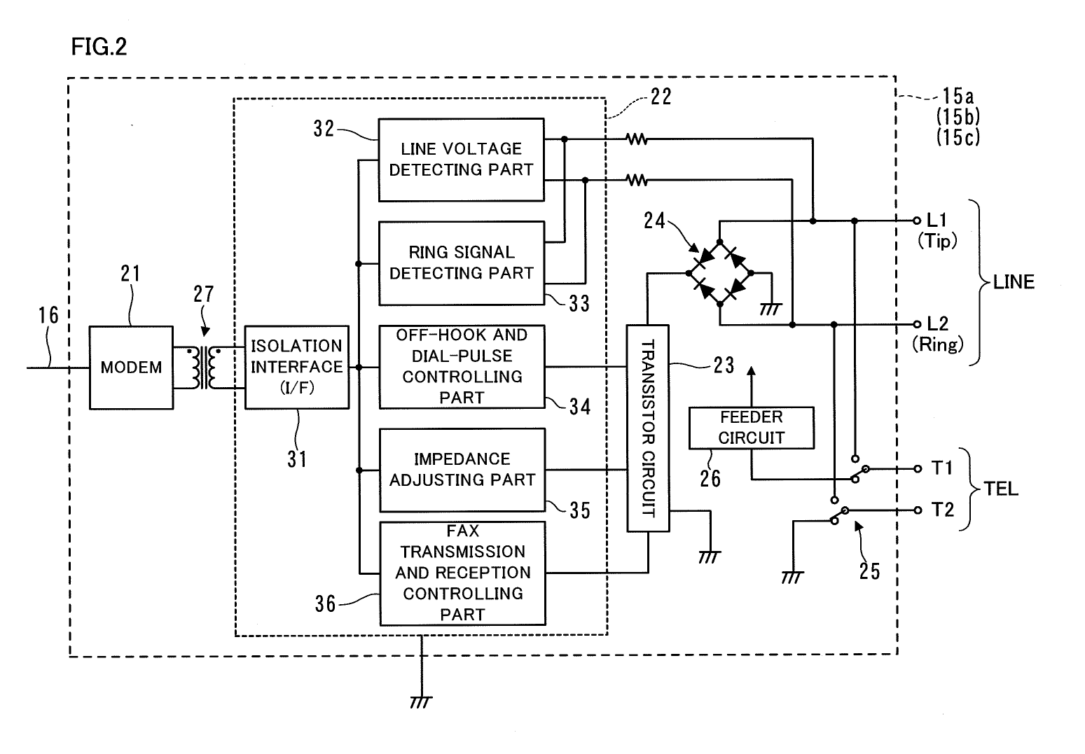

FIG. 2 is a block diagram for explaining a detailed configuration of the first communication part 15a included in the above-mentioned FAX communication unit 15. It should be noted that each of the second communication part 15b and the third communication part 15c has the same configuration as the first communication part 15a.

The first communication part 15a is provided with a modem 21, a semiconductor DAA (Data Access Arrangement) 22, a transistor circuit 23, a rectifier 24, relays 25, a feeder circuit 26 and an isolation transformer 27. In addition, the first communication part 15a is further provided with two line terminals L1 (Tip) and L2 (Ring) for connecting to the telephone network 100, and two telephone terminals T1 and T2 for connecting to an external telephone which is not shown in the figure. The first communication part 15a is provided in the form of a unit so as to be mounted in the image forming apparatus 10 in the case where a facsimile function is required in the image forming apparatus 10. Moreover, the second and third communication parts 15b and 15c are also mounted in the image forming apparatus 10 in the case where the facsimile function is required to be enhanced in the image forming apparatus 10.

The modem 21 is connected to the semiconductor DAA 22 and the bus line 16 of the image forming apparatus 10. The modem 21 is controlled by the CPU 11a of the controller 11 shown in FIG. 1. The modem 21 and the semiconductor DAA 22 are connected to each other through the isolation transformer 27. Accordingly, with respect to the isolation transformer 27, the semiconductor DAA 22 side is the primary side (a power source side), while the modem 21 side is the secondary side (a load side). The modem 21 generates a transmission signal by modulating an image signal and a communication signal received through the bus line 16, and transmits the resultant signal to the semiconductor DAA 22. In addition, the modem 21 also generates an image signal by demodulating a transmission signal received from the telephone network 100 through the semiconductor DAA 22, and transmits the resultant signal to the bus line 16.

The semiconductor DAA 22 is connected to the modem 21, the line terminals L1 and L2, and the transistor circuit 23. The semiconductor DAA 22 is controlled by the CPU 11a of the controller 11 shown in FIG. 1, through the modem 21. Meanwhile, the semiconductor DAA 22 is connected to the line terminals L1 and L2 through resistors of several MΩ. The semiconductor DAA 22 mainly performs circuit termination, transmission and reception of calls, delivery of transmission signals for transmission and reception of the facsimile, and the like. Moreover, the semiconductor DAA 22 also functions as a detection unit that detects voltage generated between the line terminals L1 and L2, that is, line voltage supplied from the telephone network 100. It should be noted that a detailed configuration of the semiconductor DAA 22 will be described later.

The transistor circuit 23 is connected to the semiconductor DAA 22 and the rectifier 24. In the transistor circuit 23, the collector terminal is connected to the rectifier 24, the base terminal is connected to the semiconductor DAA 22, and the emitter terminal is grounded.

The rectifier 24 is connected to the line terminals L1 and L2, the transistor circuit 23, and a grounding conductor. When the line terminals L1 and L2 are connected to the telephone network 100 and the line voltage is applied between the terminals, and conduction is established between the collector and the emitter in the transistor circuit 23 and a closed loop is formed, the rectifier 24 rectifies the DC loop current flowing between the line terminals L1 and L2 so that the DC loop current will have a polarity in one direction.

The relays 25 are respectively provided to an interconnect line connecting the line terminal L1 and the telephone terminal T1, and an interconnect line connecting the line terminal L2 and the telephone terminal T2. The relays 25 are used to switch the terminal apparatus to be connected to the telephone network 100 through the line terminals L1 and L2, between the image forming apparatus 10 shown in FIG. 1 and the external telephone (not shown in the figure) connected to the telephone terminals T1 and T2.

The feeder circuit 26 functions as a power source for feeding the external telephone through the telephone terminal T1, when the line terminals L1 and L2 and the telephone terminals T1 and T2 are disconnected by the relays 25. It should be noted that, when the line terminals L1 and L2 and the telephone terminals T1 and T2 are disconnected by the relays 25, the telephone terminal T2 is connected to a grounding conductor.

Moreover, the isolation transformer 27 is installed between the modem 21 and the semiconductor DAA 22, and prevents the direct current from flowing to the secondary side.

Here, as long as there is no error or the like in the network, the telephone network 100 supplies a predetermined line voltage to the line terminals L1 and L2 of each of the first to third communication parts 15a to 15c. Hence, if the first communication part 15a, the second communication part 15b or the third communication part 15c is not connected to the telephone network 100, the corresponding line terminals L1 and L2 are left open, and the line voltage is not supplied thereto.

Next, a configuration of the semiconductor DAA 22 will be described in detail.

The semiconductor DAA 22 is provided with an isolation interface (I/F) 31, a line voltage detecting part 32, a ring signal detecting part 33, an off-hook and dial-pulse controlling part 34, an impedance adjusting part 35 and a FAX transmission and reception controlling part 36. It should be noted that, the isolation interface (I/F) 31, the line voltage detecting part 32, the ring signal detecting part 33, the off-hook and dial-pulse controlling part 34, the impedance adjusting part 35 and the FAX transmission and reception controlling part 36 are mutually connected through an internal bus.

The isolation I/F 31 is connected to the modem 21 through the isolation transformer 27. The isolation I/F 31 functions as an interface for communication with the modem 21.

The line voltage detecting part 32 functioning as a detection unit is connected to the line terminals L1 and L2 through the resistors. The line voltage detecting part 32 has a function of detecting whether or not the voltage is generated between the line terminals L1 and L2, that is, whether or not the line voltage is supplied from the telephone network 100 to which the line terminals L1 and L2 are connected, and detecting the value of the line voltage. It should be noted that the line voltage detecting part 32 may detect the presence or absence of a line voltage and the value of the line voltage, in each of the off-hook state and the on-hook state. The detection result of the line voltage detecting part 32 on the presence or absence of a line voltage and the value of the line voltage is stored in a register (not shown in the figure) provided in the modem 21. Then, in the present exemplary embodiment, the CPU 11a of the controller 11 detects the presence or absence of a line voltage and the value of the line voltage by referring to the register provided in the modem 21.

The ring signal detecting part 33 is also connected to the line terminals L1 and L2 through the resistors. At the time of call reception, upon input of ring signals from the telephone network 100 through the line terminals L1 and L2, the ring signal detecting part 33 outputs ring detection signals in the same cycle as the ring signals.

The off-hook and dial-pulse controlling part 34 is connected to the transistor circuit 23. The off-hook and dial-pulse controlling part 34 switches the states of the line between off-hook and on-hook through the transistor circuit 23. Additionally, at the time of call transmission, the off-hook and dial-pulse controlling part 34 carries out a call transmission operation, in which the off-hook and dial-pulse controlling part 34 outputs, to the telephone network 100, dial pulses corresponding to the destination telephone number. Here, in the present exemplary embodiment, the CPU 11a of the controller 11 is configured to perform control of restricting call transmission of the off-hook and dial-pulse controlling part 34, or of canceling the restriction. The off-hook and dial-pulse controlling part 34 is not allowed to output dial pulses when the call transmission is restricted, but is allowed to output dial pulses when the restriction on call transmission is canceled.

The impedance adjusting part 35 is connected to the transistor circuit 23. The impedance adjusting part 35 adjusts the impedance between the line terminals L1 and L2, that is, the terminal impedance of the line, by appropriately setting the amount of base current to be supplied to the transistor circuit 23.

The FAX transmission and reception controlling part 36 is connected to the transistor circuit 23. At the time of facsimile transmission, the FAX transmission and reception controlling part 36 outputs, to the telephone network 100, a transmission signal received from the modem 21 through the isolation I/F 31. Moreover, at the time of facsimile reception, the FAX transmission and reception controlling part 36 outputs, to the modem 21 through the isolation I/F 31, a transmission signal received through the telephone network 100.

Hereinafter, a facsimile transmission operation of the image forming apparatus 10 will be described with reference to FIGS. 1 and 2. It should be noted that the transmission operation, that is, the call transmission is carried out by use of the first communication part 15a, as an example.

For example, when the image forming apparatus 10 receives a facsimile transmission instruction including a destination telephone number through the user interface unit 14, and the image reading unit 12 reads an image to be transmitted, the CPU 11a of the controller 11 issues a call transmission instruction to the first communication part 15a. The call transmission instruction is forwarded to the semiconductor DAA 22 through the modem 21 which is included in the first communication part 15a. Then, in the semiconductor DAA 22, the off-hook and dial-pulse controlling part 34 supplies a predetermined current to the base terminal of the transistor circuit 23 so as to turn on the transistor circuit 23. When the transistor circuit 23 is turned on, conduction is established between the collector terminal and the emitter terminal of the transistor circuit 23, so that the current flows between the line terminals L1 and L2. The current flow in the transistor circuit 23 as described above causes the line of the first communication part 15a to be in the off-hook state. Thus, the telephone network 100 side comes to be in the dial-stand-by state.

Additionally, the CPU 11a of the controller 11 carries out the following operation simultaneously with the above operation: adding a predetermined communication signal to an image signal acquired through the read-out operation performed by the image reading unit 12; and outputting the signals to the modem 21 of the first communication part 15a. Thereafter, the modem 21 generates a transmission signal by modulating the received image signal and communication signal, and outputs the transmission signal to the FAX transmission and reception controlling part 36 in the semiconductor DAA 22.

Subsequently, the CPU 11a of the controller 11 issues a dial instruction to the semiconductor DAA 22 through the modem 21 of the first communication part 15a. In response, the off-hook and dial-pulse controlling part 34 in the semiconductor DAA 22 outputs pulse signals corresponding to the destination telephone number. The pulse signals outputted from the off-hook and dial-pulse controlling part 34 is transmitted through the telephone network 100 from the line terminals L1 and L2 to an exchanger (not shown in the figure).

Then, when a destination facsimile (not shown in the figure) is connected through the telephone network 100, the FAX transmission and reception controlling part 36 of the first communication part 15a transmits the transmission signal received from the modem 21 to the destination facsimile through the telephone network 100. Thereafter, upon completion of transmission of the transmission signal, the FAX transmission and reception controlling part 36 transmits a signal indicating the completion of the transmission to the off-hook and dial-pulse controlling part 34. In response, the off-hook and dial-pulse controlling part 34 stops the current supply to the base terminal of the transistor circuit 23, thereby turning off the transistor circuit 23. When the transistor circuit 23 is turned off, the conduction is no longer established between the collector terminal and the emitter terminal thereof, so that the current does not flow between the line terminals L1 and L2. No current flow in the transistor circuit 23 as described above causes the line of the first communication part 15a to be in the on-hook state. Thus, the transmission operation is completed.

Next, a facsimile reception operation of the image forming apparatus 10 will be described. It should be noted that the reception operation, that is, the call reception is carried out by use of the first communication part 15a, as an example.

For example, when the first communication part 15a receives a ring signal from a destination facsimile (not shown in the figure) through the telephone network 100, the ring signal detecting part 33 of the semiconductor DAA 22 in the first communication part 15a detects the ring signal, and transmits, to the off-hook and dial-pulse controlling part 34, a ring detection signal indicating the detection of the ring signal. Then, the off-hook and dial-pulse controlling part 34 supplies a predetermined current to the base terminal of the transistor circuit 23 so as to turn on the transistor circuit 23. When the transistor circuit 23 is turned on, the conduction is established between the collector terminal and the emitter terminal of the transistor circuit 23, so that the current flows between the line terminals L1 and L2. The current flow in the transistor circuit 23 as described above causes the line of the first communication part 15a to be in the off-hook state. Thus, the telephone network 100 side comes to be in the reception waiting state.

Then, when a destination facsimile is connected through the telephone network 100, the FAX transmission and reception controlling part 36 of the first communication part 15a start receiving a transmission signal transmitted from the destination facsimile through the telephone network 100. Thereafter, upon completion of the reception of the transmission signal, the FAX transmission and reception controlling part 36 transmits a signal indicating the completion of the reception to the off-hook and dial-pulse controlling part 34. In response, the off-hook and dial-pulse controlling part 34 stops the current supply to the base terminal of the transistor circuit 23, thereby turning off the transistor circuit 23. When the transistor circuit 23 is turned off, the conduction is no longer established between the collector terminal and the emitter terminal thereof, so that the current does not flow between the line terminals L1 and L2. No current flow in the transistor circuit 23 as described above causes the line of the first communication part 15a to be in the on-hook state. Thus, the reception operation is completed.

It should be noted that the transmission signal received by the FAX transmission and reception controlling part 36 of the first communication part 15a at the reception operation is transmitted to the modem 21 and is demodulated. Then, the CPU 11a of the controller 11 causes the demodulated image signal to be transmitted to the print processing unit 13 through the bus line 16. Thereafter, the print processing unit 13 forms an image according to the received image signal on a paper sheet, and outputs it.

In the image forming apparatus 10, facsimile is transmittable by use of any of the first to third communication parts 15a to 15c, as mentioned above. However, even though all the first to third communication parts 15a to 15c are connected to the telephone network 100 for example, a line error or the like may occur in a part of the line side, and thereby facsimile may not be transmitted through this line. In addition, in the case where only the first and second communication parts 15a and 15b are connected to the telephone network 100 and the third communication part 15c is not connected thereto for example, facsimile may not be transmitted by use of the third communication part 15c.

Therefore, in the present exemplary embodiment, the image forming apparatus 10 detects the values of line voltages respectively supplied to the first to third communication parts 15a to 15c by use of the line voltage detection functions of the semiconductor DAAs 22 provided in the respective communication parts, thereby monitoring the connection state between the telephone network 100 and each of the first to third communication parts 15a to 15c. Then, the image forming apparatus 10 determines, on the basis of the detected line voltage values for the first to third communication parts 15a to 15c, whether or not call transmission is allowed by using the first to third communication parts 15a to 15c, respectively.

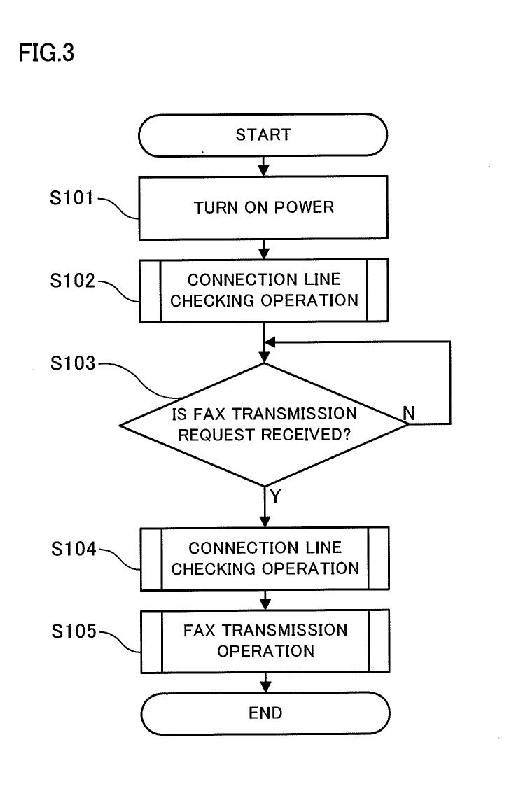

FIG. 3 is a flowchart illustrating a procedure of the various kinds of processing that is performed for the FAX communication unit 15 of the image forming apparatus 10. It should be noted that, the program on the processing is stored in the ROM 11b of the controller 11, and the CPU 11a interprets the program read from the ROM 11b and executes it.

The processing is started by pressing a switch (not illustrated in the figure) of the image forming apparatus 10 and turning on the power (step 101). When the power is turned on, the CPU 11a checks the connection state of each of the first to third communication parts 15a to 15c that are included in the FAX communication unit 15 with the telephone network 100, and executes a connection line checking operation that regulates the call transmission from the first to third communication parts 15a to 15c, as necessary (step 102). It should be noted that the connection line checking operation will be later described in detail.

After the connection line checking operation is completed in step 102, the CPU 11a determines whether or not a FAX transmission request is received through the user interface unit 14 or the like (step 103). Here, in the case where the CPU 11a determines that the FAX transmission request is not received, the process goes back to step 103 and the image forming apparatus 10 waits to receive the FAX transmission request. On the other hand, in the case where the CPU 11a determines that the FAX transmission request is received, the CPU 11a executes the same connection line checking operation as the above described step 102, again (step 104).

After the connection line checking operation in step 104 is completed, the CPU 11a causes the FAX transmission operation to be executed by using any of the first to third communication parts 15a to 15c that are included in the FAX communication unit 15 (step 105), and a series of the processing is completed. It should be noted that the FAX transmission operation is later described in detail.

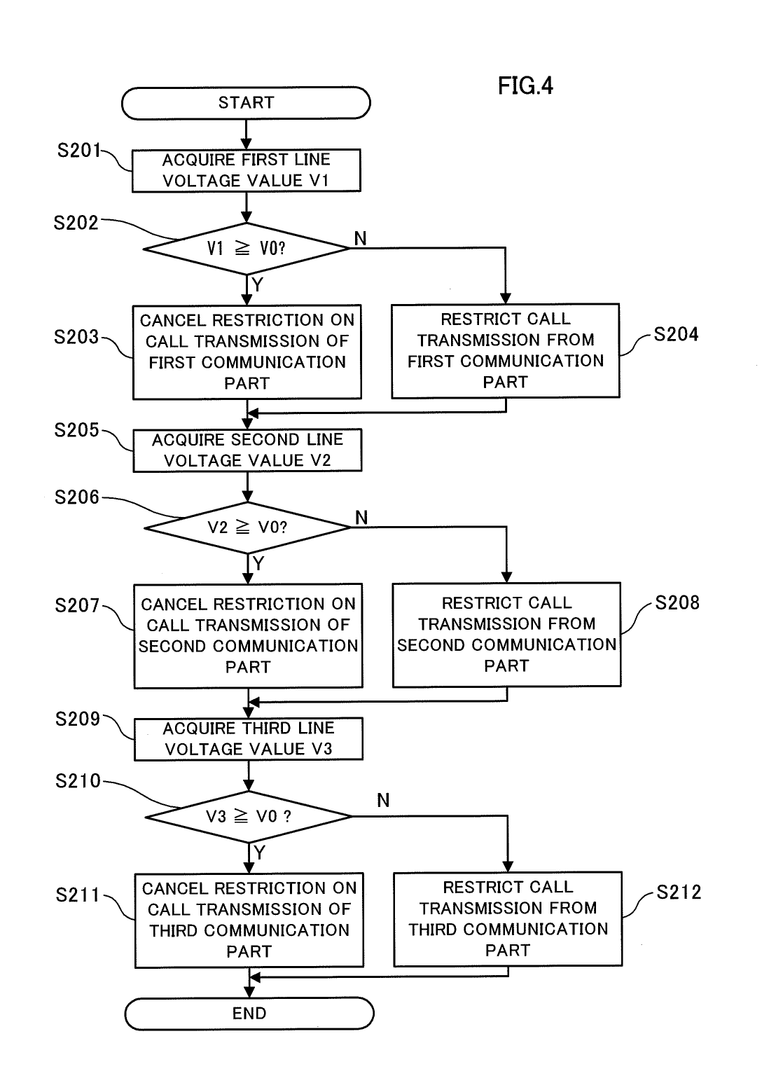

FIG. 4 is a flowchart illustrating the detailed processing procedure of the connection line checking operation mentioned above.

Firstly, the CPU 11a refers to the register provided in the modem 21 of the first communication part 15a, and acquires a first line voltage value V1 as the voltage value between the line terminals L1 and L2 of the first communication part 15a (step 201). Then, the CPU 11a determines whether or not the acquired first line voltage value V1 is equal to or greater than a reference voltage value V0 (step 202). Here, the reference voltage value V0 is set to be slightly lower (40 V, for example) than the general line voltage value (48 V, in the case of the public line, for example) in the telephone network 100. In other words, the reference voltage value V0 is a value that is determined in relation to the value of the line voltage supplied by the employed telephone line (such as the telephone network 100). In the case where the first line voltage value V1 is determined to be equal to or greater than the reference voltage value V0, the CPU 11a cancels the restriction on call transmission of the first communication part 15a (step 203), and the processing proceeds to step 205. It should be noted that the off-hook and dial-pulse controlling part 34 of the first communication part 15a becomes ready to transmit a call upon cancellation of the restriction on call transmission. In contrast, in the case where the first line voltage value V1 is determined to be smaller than the reference voltage value V0 in step 202, the CPU 11a restricts call transmission from the first communication part 15a (step 204), and the processing proceeds to step 205. It should be noted that the off-hook and dial-pulse controlling part 34 of the first communication part 15a is not allowed to transmit a call under the restriction on call transmission.

Next, the CPU 11a refers to the register provided in the modem 21 of the second communication part 15b, and acquires a second line voltage value V2 as the voltage value between the line terminals L1 and L2 of the second communication part 15b (step 205). Then, the CPU 11a determines whether or not the acquired second line voltage value V2 is equal to or greater than the reference voltage value V0 (step 206). In the case where the second line voltage value V2 is determined to be equal to or greater than the reference voltage value V0, the CPU 11a cancels the restriction on call transmission of the second communication part 15b (step 207), and the processing proceeds to step 209. It should be noted that the off-hook and dial-pulse controlling part 34 of the second communication part 15b becomes ready to transmit a call upon cancellation of the restriction on call transmission. In contrast, in the case where the second line voltage value V2 is determined to be smaller than the reference voltage value V0 in step 206, the CPU 11a restricts call transmission from the second communication part 15b (step 208), and the processing proceeds to step 209. It should be noted that the off-hook and dial-pulse controlling part 34 of the second communication part 15b is not allowed to transmit a call under the restriction on call transmission.

Thereafter, the CPU 11a refers to the register provided in the modem 21 of the third communication part 15c, and acquires a third line voltage value V3 as the voltage value between the line terminals L1 and L2 of the third communication part 15c (step 209). Then, the CPU 11a determines whether or not the acquired third line voltage value V3 is equal to or greater than the reference voltage value V0 (step 210). In the case where the third line voltage value V3 is determined to be equal to or greater than the reference voltage value V0, the CPU 11a cancels the restriction on call transmission of the third communication part 15c (step 211), and a series of the processing is completed. It should be noted that the off-hook and dial-pulse controlling part 34 of the third communication part 15c becomes ready to transmit a call upon cancellation of the restriction on call transmission. In contrast, in the case where the third line voltage value V3 is determined to be smaller than the reference voltage value V0 in step 210, the CPU 11a restricts call transmission from the third communication part 15c (step 212), and a series of the processing is completed. It should be noted that the off-hook and dial-pulse controlling part 34 of the third communication part 15c is not allowed to transmit a call under the restriction on call transmission.

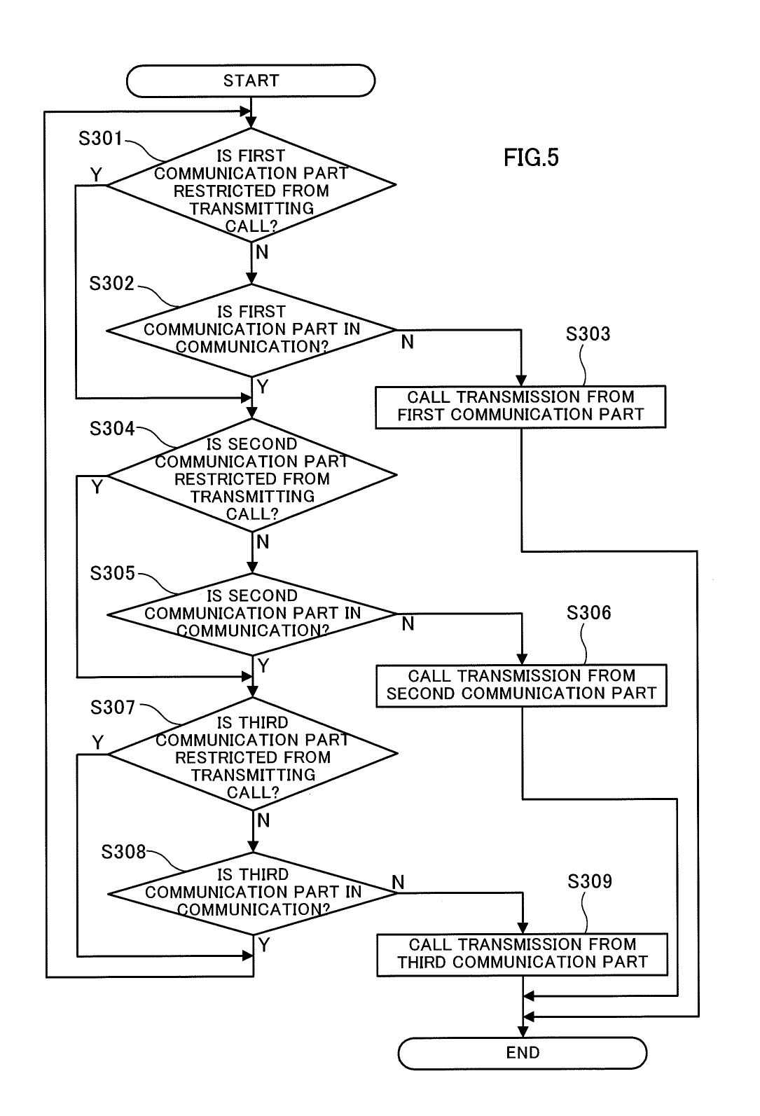

FIG. 5 is a flowchart illustrating the detailed processing procedure of the FAX transmission operation as mentioned above.

Upon reception of the FAX transmission request, the CPU 11a firstly determines whether or not the first communication part 15a is restricted from transmitting a call (step 301). In the case where the CPU 11a determines that the first communication part 15a is restricted from transmitting a call, the processing proceeds to a later-described step 304. On the other hand, in the case where the CPU 11a determines that the first communication part 15a is not restricted from transmitting a call, the CPU 11a further determines whether or not the first communication part 15a is in communication (in use) (step 302). In the case where the CPU 11a determines that the first communication part 15a is in communication, the processing proceeds to the later-described step 304. On the other hand, in the case where the CPU 11a determines that the first communication part 15a is not in communication, the CPU 11a transmits a control signal to the first communication part 15a and causes the call to be transmitted from the first communication part 15a (step 303), and a series of the processing is completed. It should be noted that in the case where connection fails after the call transmission, the CPU 11a causes the call transmission to be repeated a predetermined number of times by the first communication part 15a.

In the case where the CPU 11a determines that the first communication part 15a is restricted from transmitting a call in the above step 301 and that the first communication part 15a is in communication in the above step 302, the CPU 11a further determines whether or not the second communication part 15b is restricted from transmitting a call (step 304). In the case where the CPU 11a determines that the second communication part 15b is restricted from transmitting a call, the processing proceeds to a later-described step 307. On the other hand, in the case where the CPU 11a determines that the second communication part 15b is not restricted from transmitting a call, the CPU 11a further determines whether or not the second communication part 15b is in communication (step 305). In the case where the CPU 11a determines that the second communication part 15b is in communication, the processing proceeds to the later-described step 307. On the other hand, in the case where the CPU 11a determines that the second communication part 15b is not in communication, the CPU 11a transmits a control signal to the second communication part 15b and causes the call to be transmitted from the second communication part 15b (step 306), and a series of the processing is completed. It should be noted that, in the case where connection fails after the call transmission, the CPU 11a causes the call transmission to be repeated a predetermined number of times by the second communication part 15b.

In the case where the CPU 11a determines that the second communication part 15b is restricted from transmitting a call in the above step 304 and that the second communication part 15b is in communication in the above step 305, the CPU 11a further determines whether or not the third communication part 15c is restricted from transmitting a call (step 307). In the case where the CPU 11a determines that the third communication part 15c is restricted from transmitting a call, the processing goes back to the above-described step 301. On the other hand, in the case where the CPU 11a determines that the third communication part 15c is not restricted from transmitting a call, the CPU 11a further determines whether or not the third communication part 15c is in communication (step 308). In the case where the CPU 11a determines that the third communication part 15c is in communication, the processing goes back to the above-described step 301. On the other hand, in the case where the CPU 11a determines that the third communication part 15c is not in communication, the CPU 11a transmits a control signal to the third communication part 15c and causes the call to be transmitted from the third communication part 15c (step 309), and a series of the processing is completed. It should be noted that, in the case where connection fails after the call transmission, the CPU 11a causes the call transmission to be repeated a predetermined number of times by the third communication part 15c.

As mentioned above, in the present exemplary embodiment, the CPU 11a of the image forming apparatus 10 restricts call transmission from a communication part having a line voltage value that is smaller than a reference voltage value among the first to third communication parts 15a to 15c, so that a call may not be transmitted from the communication part. Moreover, in transmitting a facsimile, the CPU 11a sequentially refers to the first to third communication parts 15a to 15c, and causes the facsimile to be transmitted by use of the communication part which is not restricted from transmitting a call, in other words, the communication part free from the restriction on call transmission. Use of this configuration reduces transmission errors that may occur in the case of facsimile transmission through a line which may cause transmission errors by its extremely low line voltage value. Additionally, the configuration also avoids a facsimile transmission error, for example, in the case where any of the first to third communication parts 15a to 15c is not connected to the telephone network 100.

In the present exemplary embodiment, the CPU 11a carries out the connection line checking operation when the image forming apparatus 10 becomes powered on, and when a facsimile transmission is requested. However, it is not limited to the cases. For example, in the case where the image forming apparatus 10 is provided with a power saving mode (sleep mode) in which some functions of the print processing unit 13 or the like is halted when the image forming apparatus 10 has not been used for a predetermined time, the CPU 11a may carry out the connection line checking operation when the image forming apparatus 10 returns from the power saving mode. In addition, the CPU 11a may carry out the connection line checking operation when receiving an execution request for the operation from a user through the user interface unit 14, for example.

Moreover, in the present exemplary embodiment, although a description has been given for the FAX communication unit 15 including the first to third communication parts 15a to 15c as an example, it is not limited to this configuration, and it is enough if multiple communication parts are provided.

The exemplary embodiment described above may be executed by a program that causes a computer including the CPU 11a, the ROM 11b and the RAM 11c of the image forming apparatus 10 shown in FIG. 1 to implement the function. In such a case, the program may be stored in the ROM 11b for example, or may also be provided by being recorded in a recording medium such as a CD-ROM.

Further, in the exemplary embodiment, although an example in which the invention is applied to a facsimile has been described, it is apparent that it is also applied to a communication device such as a telephone by replacing the image signal explained here with an audio signal.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A communication apparatus comprising:
a plurality of transmission units that respectively transmit communication signals through a telephone line;
a detection unit that detects a value of a line voltage supplied from the telephone line to each of the plurality of transmission units; and
a controller that controls transmission from each of the plurality of transmission units, according to a relation between a predetermined reference voltage value and the value of the line voltage of each of the plurality of transmission units detected by the detection unit.

2. The communication apparatus according to claim 1, wherein the controller restricts transmission from a transmission unit whose value of the line voltage detected by the detection unit is smaller than the reference voltage value, among the plurality of transmission units.

3. The communication apparatus according to claim 2, further comprising an instruction unit that issues a transmission instruction to a certain transmission unit among the plurality of transmission units, and that issues a transmission instruction to other transmission unit among the plurality of transmission unit in a case where the certain transmission unit is in use, wherein
the instruction unit does not issue a transmission instruction to the transmission unit from which the controller restricts transmission.

4. The communication apparatus according to claim 1, wherein the controller allows transmission from a transmission unit whose value of the line voltage detected by the detection unit is greater than the reference voltage value, among the plurality of transmission units.

5. The communication apparatus according to claim 1, further comprising a reception unit that receives an information transmission request, wherein
the detection unit detects the value of the line voltage supplied from the telephone line to each of the plurality of transmission units in the case where the reception unit receives the information transmission request.

6. The communication apparatus according to claim 1, wherein
each of the plurality of transmission units includes corresponding one of a plurality of semiconductor data access arrangements (DAAs), and
the detection unit is provided in each of the plurality of semiconductor DAAS.

7. The communication apparatus according to claim 1, wherein the reference voltage value is a value related to the value of the line voltage supplied from the telephone line.

8. A communication method of an apparatus including a plurality of transmission units that respectively transmit communication signals through a telephone line, comprising:
detecting a value of a line voltage supplied from the telephone line to each of the plurality of transmission units; and
controlling transmission from each of the plurality of transmission units, according to a relation between a predetermined reference voltage value and the value of the line voltage of each of the plurality of transmission units that is detected.

9. The communication method according to claim 8, wherein transmission is controlled so that transmission from a transmission unit, among the plurality of the transmission units, whose detected value of the line voltage is smaller than the reference voltage value is restricted.

10. The communication method according to claim 9, further comprising issuing a transmission instruction to a certain transmission unit among the plurality of transmission units, issuing a transmission instruction to other transmission unit among the plurality of transmission units in a case where the certain transmission unit is in use, and not issuing a transmission instruction to the transmission unit from which transmission is restricted.

11. The communication method according to claim 8, wherein the reference voltage value is a value related to the value of the line voltage supplied from the telephone line.

12. A computer readable medium storing a program causing a computer to execute a process for performing communication, the process comprising:
transmitting communication signals through a telephone line from a plurality of transmission units;
detecting a value of a line voltage supplied from the telephone line to each of the plurality of transmission units; and
controlling transmission from each of the plurality of transmission units, according to a relation between a predetermined reference voltage value and the value of the line voltage of each of the plurality of transmission units that is detected.
